(19) United States
(12) Patent Application Publication
(10) Pub. No.: US 2007/0025563 A1
(43) Pub. Date: Feb. 1, 2007

(54) Snapshot of noise and acoustic propagation

(75) Inventor: Sean F. Wu, Troy, MI (US)

Correspondence Address: CARLSON, GASKEY & OLDS, P.C., 400 WEST MAPLE ROAD, SUITE 350, BIRMINGHAM, MI, 48009, US

(73) Assignee: Wayne State University

(21) Appl. No.: 11/484,499

(22) Filed: Jul. 11, 2006

Related U.S. Application Data
(60) Provisional application No. 60/698,406, filed on Jul. 12, 2005.

(51) Int. Cl. H04B 15/00

(52) U.S. Cl. 381/94.1

(57) ABSTRACT

A system extracts the sound spectrum and sound pressure level (SPL) values of a target source in a non-ideal environment. This system can be critical for in-line or end-of-line quality control (QC) testing of sound-producing products in a manufacturing environment in which background noise level is high. The underlying principle of this system is the assumption that the sound field can be described using two sets of expansion functions, one for direct sound radiation from a target source and the other for the background sounds that travel in the opposite direction as that of direct sound from the target. The coefficients associated with these expansion functions are determined in a similar manner as those in the Helmholtz Equation Least Squares (HELS) method. Once the expansion coefficients are determined, however, only the direct sound spectrum and corresponding SPL value are displayed. This allows for suppression of background noise produced by the neighboring sources and reflections from nearby surfaces.

This application claims priority to U.S. Provisional Application Ser. No. 60/698,406, filed Jul. 12, 2005.

### BACKGROUND OF INVENTION

This invention provides a method and system for rapid diagnosis of the sound spectrum and sound pressure level (SPL) values of a target source in a non-ideal environment with improved speed and efficiency. Because of its speed and efficiency even in noisy environments, the invention is useful for in-line or end-of-line quality control (QC) testing of sound-producing products in a general manufacturing environment.

Currently, QC testing is conducted inside a quiet chamber that is separated from an assembly line or inside an enclosure designed and installed on a particular assembly line. The downsides of these approaches are that: 1) QC process becomes costly because of the costs involved in building the chamber or enclosure; 2) QC testing is time consuming because the product must be transported to and from the chamber; 3) testing efficiency is reduced because additional procedures are involved; and 4) the effectiveness of a quiet chamber or enclosure depends on its dimensions. The larger the chamber or enclosure is, the more effective it is, but the higher the costs become.

Alternatively, one can use a probe that consists of a small number of microphones to take spatial averages of the acoustic pressure. This method is very convenient to use in practice. The disadvantages of this approach, however, are that: 1) the measured data are highly position dependent; 2) the results may be contaminated by background noise; 3) the results can display large fluctuations due to the presence of background noise; and 4) false diagnosis can occur, which leads to rejection of good products or acceptance of bad products.

Intensity probes or beamforming techniques are not suitable for locating a sound source in a manufacturing environment where background noise level may be high. An intensity probe captures the total acoustic intensity at any measurement point, including both propagating and non-propagating components of the acoustic intensity, when measurement is taken at a very close distance to a target source. Moreover, the measured value consists of the acoustic intensity produced by a target source and those by the neighboring sources or reflected from nearby surfaces. Consequently, an intensity probe cannot offer much useful information when there are multiple sources or reflecting surfaces.

Beamforming is used to discern the direction in which a sound wave is propagating. Its spatial resolution is no better than one wavelength of the sound of interest. In other words, it cannot discern two sound sources that are separated by a distance less than one wavelength of the emitted sound. Therefore, beamforming may be useful for high-frequency sounds, but not for low-frequency sounds. Moreover, beamforming assumes a plane wave propagation and projects sound from one plane to another. Consequently, it may be suitable for locating sound sources on a planar surface, but not suitable for a general 3D surface. Like an intensity probe, beamforming is not suitable when background noise is high.

### SUMMARY OF INVENTION

The technique described herein is derived from the HELS (Helmholtz Equation Least Squares) method, disclosed in U.S. Pat. No. 5,712,805, which is used to reconstruct the acoustic field, including the acoustic pressures, particle velocities, and acoustic intensities in 3D space and on 3D source surfaces. Note that the original HELS method allows for reconstruction of the total field that consists of the acoustic quantities radiated from a target source, those radiated from neighboring sources and reflected from nearby surfaces. Thus, HELS method cannot be used to analyze the characteristics of a target source in a non-ideal environment in which the background noise level may be high.

Unlike the original HELS method, the present invention describes the sound field using two sets of expansion functions, one for direct sound radiation from a target source and the other for the background sounds that travel in the opposite direction as that of direct sound from the target. The coefficients associated with these expansion functions are determined in a similar manner as those in the HELS method. Once the expansion coefficients are determined, however, we display the sound spectrum and SPL values using the set of expansion functions that describe direct sound radiation from a target. In this way, we can effectively eliminate background sounds produced by neighboring sources and reflections from nearby surfaces.

This new technology can be implemented in two ways. The first utilizes an array of microphones that encircle a target, and the second utilizes a single probe consisting of a small number of microphones that can be moved around and take measurements anywhere.

By encircling a target source, we can effectively eliminate the background sound coming from all directions. Since there are no sound source and reflecting surface other than the target inside a microphone ring, we can treat the sound emitted from a target as the direct sound traveling toward microphones and sounds radiated from neighboring sources and reflected from nearby surfaces as background sounds traveling in the opposite direction as that of direct sound. This scenario matches perfectly the acoustic model adopted in the present invention. Hence, this approach can yield accurate and repeatable results and is very robust in a non-ideal environment. However, it requires setting up a microphone array and fixing it to a target, thus it is less mobile.

By using a microphone probe, we can take a measurement anywhere. Therefore, the second approach is very convenient, flexible, easy to use in practice, and requires no set up of the measurement device. However, its accuracy may depend on the location of the background noise sources. If background noise sources are behind a target source but all in front of the microphone probe, the microphone probe will capture sound from the target source and that from background noise sources, all traveling in the same direction. In other words, the direct sound in the acoustic model will include sounds from the target and background noise sources. Meanwhile, the sounds traveling in the opposite direction are minimal. Under this condition, there is no way to separate the sound from the target source and those from background sounds.

However, when background noise sources are behind the microphone probe and the target is in front of the microphone probe such that the direct sound from the target travels in the opposite direction as those of background sounds, we can extract the sound emitted from a target accurately from the overall acoustic field. Consequently, in using a microphone probe one should take advantage of any prior knowledge of the locations of background noise sources, place the microphone probe between the target source and background sources, and point it at the target source. This will provide very accurate results even in a very noisy environment. Note that the background noise sources do not need to be in line with the target and microphone probe and directly behind the probe. As long as background sounds are not traveling toward the microphone probe, they can be suppressed at least to a great extent.

The present technique is not limited to a planar surface or a quiet environment. It is fast, convenient, accurate, very low cost, and capable of extracting the acoustic pressure and spectrum radiated by a target source from the overall sound pressure field. In other words, it enables one to suppress unwanted sounds that include those radiated from neighboring sources and reflected from nearby surfaces, estimate the direct sound power from a target source, and assess its characteristics in a non-ideal environment.

It is emphasized that: (1) any measurement device, for example, a microphone or an intensity probe, measures the overall sound field that consists of the acoustic pressure emitted by a target source and those emitted by neighboring sources or reflected from nearby surfaces; (2) it is impossible for any measurement device to discard or suppress the unwanted background sounds imbedded in measured data; and (3) although the present technology cannot completely eliminate all unwanted background sounds, it is the most efficient way available to extract sound radiation from a source in noisy environment. This invention provides a QC tool for in line and end-of-line testing of products in a manufacturing environment in which background noise level may be very high.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a first embodiment of a noise diagnostic system according to the present invention using a plurality of microphone rings.

FIG. 2 illustrates a second embodiment of a noise diagnostic system according to the present invention using a microphone probe.

### DETAILED DESCRIPTION OF A PREFERRED EMBODIMENT

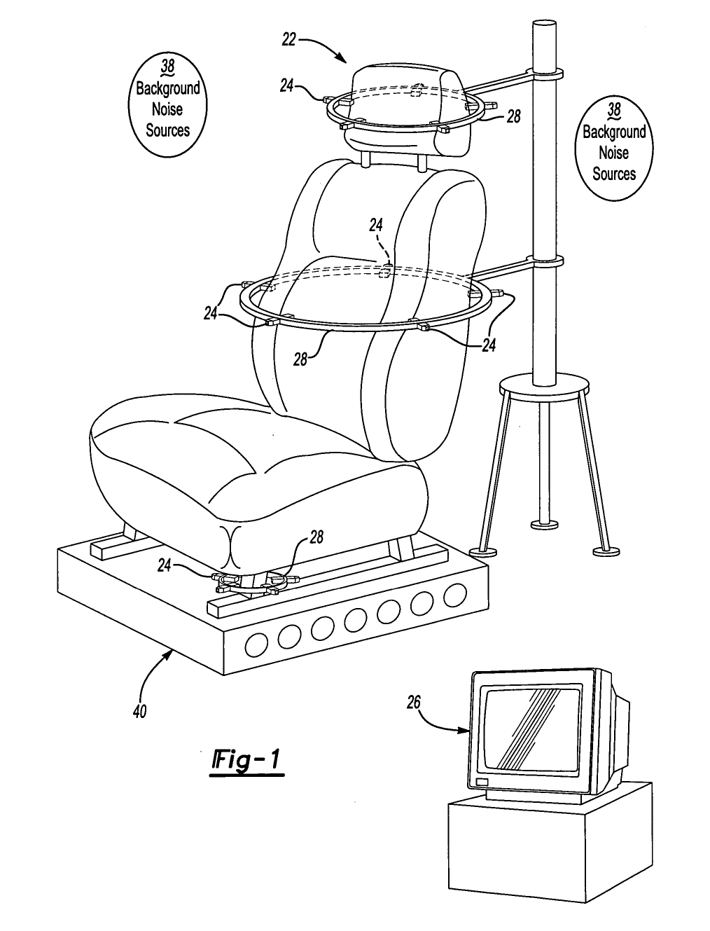

A first example of a noise diagnostic system 20 according of the present invention is shown in FIG. 1 taking measurements from a noise source 22, in this case a vehicle seat. The system 20 generally comprises a plurality of transducers 24, such as microphones, connected to a computer 26 (connections not shown). The computer 26 may include additional hardware such as a signal analyzer or a digital sound processing computer board (not shown). As is well-known, the computer 26 includes a processor operating a computer programs stored on computer storage media, which may be one or more of RAM, ROM, hard-drive, CD-ROM, DVD, optical, electronic or magnetic media, or any other computer-readable medium. Computer media stores a computer program, which when executed by processor performs the steps described below, including performance of the algorithms of the present invention described below.

In FIG. 1, each of the transducers 24 are mounted to a ring 28 that surrounds a portion of the noise source 22 (three rings 28 are shown in FIG. 1, but more or fewer could be used). In the example shown, five transducers 24 are mounted to each ring 28, but more or fewer could be used. In general, the more transducers 24 that are used, the higher the accuracy of the extracted direct sound can be. The present method has no restrictions whatsoever on the number of transducers 24 used in implementation. The transducers 24 are directed toward the noise source 22 and may be spaced substantially equally about the circumference of the ring 28. The ring 28 can be circular or elliptical or otherwise shaped, as long as some of the transducers 24 are directed toward the noise source 22 from different directions. The transducers 24 are between the target noise source 22 and any background noise sources 38 that may be on all sides of the target noise source 22, as shown. Background noise sources 38 can include reflective surfaces that simply reflect noise from target noise source 22.

Generally, in operation, the transducers 24 measure the frequency and amplitude of sound from the noise source 22. The gathered data is sent to the computer 26, which utilizes an inventive method, which will be more fully explained below, to determine the noise generated by the noise source 22.

In the example setup shown in FIG. 1, the noise source 22 is mounted on a silent shaker 40, since this particular noise source 22 (a vehicle seat) does not generate noise without externally induced vibration. Other noise sources, such as engines, may generate noise without external excitation.

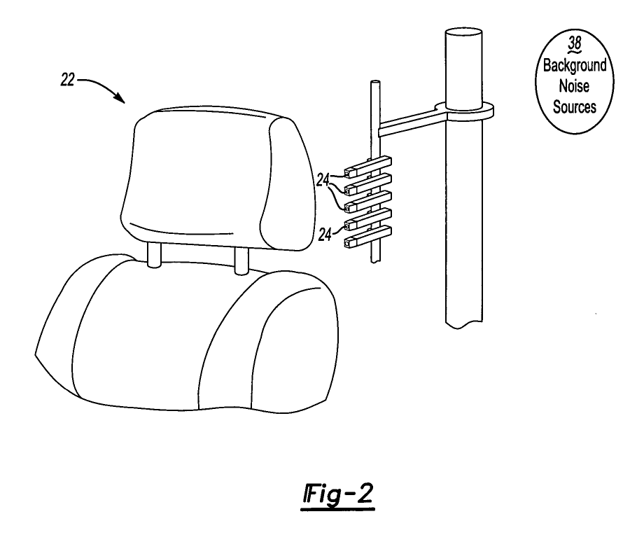

In the example of FIG. 2, the transducers 24 are all generally on the same side of the noise source 22. The transducers 24 are between the target noise source 22 and any background noise sources 38 that must be substantially (but not completely) to one side of the target noise source 22, as shown.

The underlying principle of the present invention is to express the sound directly radiated from a target source 22 in terms of an expansion of outgoing waves, and background sound in terms of an expansion of incoming waves. Mathematically, we can write this expression as

$$p ( x ; ω ) = {\sum }_{j = 1}^{J} {Ψ}_{j}^{( 1 )} ( x ; ω ) {C}_{j} ( ω ) + {\sum }_{j = 1}^{J} {Ψ}_{j}^{( 2 )} ( x ; ω ) {D}_{j} ( ω ) , \qquad ( 1 )$$

where Ψⱼ⁽¹⁾ is given by
Ψⱼ⁽¹⁾≡Ψₙₗ⁽¹⁾(r, θ,φ;ω)=hₙ⁽¹⁾(kr)Yₙ^{l}(θ,φ), (2)

where hₙ⁽¹⁾(kr) implies the spherical Hankel functions of order n of the first kind, k is the acoustic wavenumber, Yₙ^{l}(θ,φ) are the spherical harmonics, the indices j, n, and l in (2) are related via j=n²+l+1 with n starting from 0 to N and l varying from −n to n, and Ψⱼ⁽²⁾ in Eq. (1) symbolizes Ψⱼ⁽²⁾≡Ψₙₗ⁽²⁾(r,θ,φ)=hₙ⁽²⁾(kr)Yₙ^{l}(θ,φ), where hₙ⁽²⁾(kr) is the spherical Hankel functions of order n of the second kind. Physically, the terms on the right side of Eq. (1) stand for the outgoing and incoming spherical waves, which describe the sound radiated from a target and those from neighboring sources and reflections from nearby surfaces, respectively.

Equation (1) is the basis of this invention. The expansion coefficients Cⱼ(ω) and Dⱼ(ω) are determined by matching the assumed-form solution to the measured data. The errors incurred in this process are minimized by least squares method and an optimization procedure.¹ Once these coefficients are specified, however, we only plot the acoustic pressure using the first set of expansion functions

$${\sum }_{j = 1}^{J} {Ψ}_{j}^{( 1 )} ( x ; ω ) {C}_{j} ( ω ) ,$$

which enables us to extract the acoustic pressure radiated directly from a target source out of the overall acoustic pressure field. This approach is typically implemented by constructing an array of microphones that completely encircle a target source. Using Eq. (1), we can effectively eliminate background sounds traveling in all directions and estimate the sound power radiated directly from the target source.

One major requirement in QC applications is the testing speed. This is because on an assembly line, there is very little time to check products and make “go” or “no-go” decisions. To speed up the process, we can reduce the number of microphones to a minimum. Accordingly, we can simplify Eq. (1) to

$$\begin{matrix}p ( x ; ω ) = {h}_{0}^{( 1 )} ( kr ) {Y}_{0}^{0} ( θ , ϕ ) {C}_{0} ( ω ) + \\ {h}_{1}^{( 1 )} ( kr ) {Y}_{1}^{0} ( θ , ϕ ) {C}_{1} ( ω ) + \\ {h}_{0}^{( 2 )} ( kr ) {Y}_{0}^{0} ( θ , ϕ ) {D}_{0} ( ω ) + \\ {h}_{1}^{( 2 )} ( kr ) {Y}_{1}^{0} ( θ , ϕ ) {D}_{1} ( ω ) ,\end{matrix} \qquad ( 3 )$$

where the spherical Hankel functions and spherical harmonics are given by³

$$\begin{matrix}{h}_{0}^{( 1 )} ( kr ) = {ⅇ}^{ⅈ kr} / ( ikr ) , & ( 4 a ) \\ {h}_{0}^{( 2 )} ( kr ) = ⅈ {ⅇ}^{- ⅈ kr} / ( kr ) , & ( 4 b ) \\ {h}_{1}^{( 1 )} ( kr ) = - {ⅇ}^{ⅈ kr} ( i + kr ) / {( kr )}^{2} , & ( 4 c ) \\ {h}_{1}^{( 1 )} ( kr ) = {ⅇ}^{- ⅈ kr} ( i - kr ) / {( kr )}^{2} , & ( 4 d ) \\ {Y}_{0}^{0} ( θ , ϕ ) = \sqrt{\frac{1}{4 π}} , & ( 4 e ) \\ {Y}_{1}^{0} ( θ , ϕ ) = \sqrt{\frac{3}{4 π}} cos θ , & ( 4 f )\end{matrix}$$

Note that the first term on the right side of Eq. (3) represents a monopole source, which indicates that sound is generated by a time-rate of change in volume or mass flow into the surround medium, whereas the second term indicates a dipole source, which means that sound is produced by a time-rate of change in force acting on the surrounding medium. The last two terms on the right side of Eq. (3) imply monopole and dipole sounds traveling in the opposite direction as that of direct sound radiation from the target.

Accordingly, there are four coefficients C₀(ω), C₁(ω), D₀(ω), and D₁(ω) to be determined. This is done by matching the assumed-form solution, Eq. (3), to the measured sound pressures. To minimize errors incurred in this process, we take more than four measurements and form an over-determined system of equations, and then solve this system of equations using least squares. Once these coefficients are specified, we plot the sound pressure radiated directly from a target source using the first term, the second term, or combination of these two terms, depending on any prior knowledge of sound generation mechanisms of target sources. If no such knowledge whatsoever is available, it is a good idea to depict the direct acoustic pressure, at least to the first order approximation, as
p(x; ω)=h₀⁽¹⁾(kr)Y₀⁰(θ,φ)C₀(ω). (5)

This approach can be implemented by using a five-microphone probe. As pointed out above, we should place this probe between a target source and neighboring sources and point it at the target in order to extract the direct sound from the target source accurately.

It is emphasized that the aforementioned approach represents an approximation of direct sound radiation from a target source in the presence of unspecified background noises. It is impossible to extract direct sound radiation from a general source out of an overall sound field in the presence of unspecified background noises. In most circumstances, exact solutions simply do not exist. Any attempt to acquire the exact solution is bound to be fruitless. Under this condition, it is better to develop an approximate yet cost-effective method to conduct quick and reliable QC testing in a non-ideal environment. The present invention aims at achieving such a goal using an approximate acoustic model to extract direct sound radiation from a target source in the presence of unspecified background noises. In particular, this method requires very few microphones and minimum hardware system, making it potentially a very cost-effective QC tool.

### Procedures

In a manufacturing environment, there may be unspecified numbers of background noise sources 38 and the overall background noise level may be relatively high. It is desirable to identify the SPL value and spectrum of a sound-producing product, such as target noise source 22, in order to determine whether it meets the specified noise specifications, such as may be set forth by local and federal governments, by manufacturing industries, by consumers, by the manufacturer of the product, etc.

The procedures involved in using the present technology to extract the true sound characteristics of a target source from an overall sound field are described as follows.

First, we consider the case in FIG. 1 in which the product (noise source 22) is standing alone and there is enough room to install an array of microphones (transducers 24) that can encircle the target noise source 22. The background sounds are produced by neighboring background noise sources 38 around this target or ambient noise from heating, ventilation, and air conditioning (HVAC) system and operators are working in and around the vicinity.

1. Build an array of transducers 24 that encircle a target noise source 22. The transducer 24 can be a ¼ inch probe microphone and the ring 28 be made of 1/4 inch diameter copper tubing that is flexible enough to be bent in any shape and form but strong enough to hold several microphones. Measurement distances of individual microphones to the target noise source 24 surface should be equal to ensure consistence in the measurement accuracy.

2. Use a sonic digitizer or any device to acquire coordinates of each measurement microphone 24 and transfer these data to the computer 26 that controls the data acquisition process.

3. Use this array of microphones 24 to measure the acoustic pressures radiated from the target noise source 22. These signals can be averaged over time to produce the SPL values and time-averaged spectrum when the product runs under a stationary condition, or measured without time averages to produce a spectrogram and the corresponding SPL values at any instance and frequency.

4. The measured acoustic pressures are taken as input to Eq. (1) to determine the expansion coefficients. The least squares method and an optimization procedure are employed to minimize the errors and to determine an optimal number of expansion Jop.

5. Once this is done, the direct sound radiated from the target source 22 can be expressed as

$${p}_{dir} ( x ; ω ) = {\sum }_{j = 1}^{{J}_{op}} {Ψ}_{j}^{( 1 )} ( x ; ω ) {C}_{j} ( ω ) , \qquad ( 6 )$$

where P_{dir}(x;ω) represents the direct sound emitted by the target source and Jₒₚ is an optimal number of expansion terms determined by an optimization process.

6. The results can be displayed in time-averaged spectrum or spectrogram and the accuracy of the extracted direct acoustic pressure is usually quite high and consistent, regardless how and where background noises are generated. The results can be displayed on the display of the computer 26 or sent to another computer.

Next, we consider the case in FIG. 2 in which a target noise source 22 is close to or connected to some neighboring machines (background noise sources 38), and major background noises are known to come from one or more sources in specific directions. Under this condition, we can use a probe that consists of a finite number of microphones 24. This approach offers a great flexibility in taking measurement anywhere and requires no set up of test equipment. So QC testing can be very fast and efficient.

1. Build a probe that consists of a finite number of microphones 24 with a fixed and rigid configuration. The relative positions and coordinates of microphones 24 are known, so there is no need to acquire the coordinates of measurement microphones 24. The probe can be moved to any location and be used to take measurements at any angle.

2. Use this array of microphones 24 to measure the acoustic pressures radiated from a target noise source 22. As in the case of a microphone ring, the signals can be averaged over time to produce SPL values and time-averaged spectrum if the product runs under a stationary condition, or measured without any time averages to produce spectrogram and corresponding SPL values at any instance and frequency.

3. The measured acoustic pressures are then taken as input to Eq. (3) to determine the expansion coefficients.

4. Once this is done, the direct sound radiated from the target noise source 22 can be given by the first or second term on the right side of Eq. (3), or their combination. In general, it may be acceptable to use the first term only. Thus, we can write
p_{dir}(x;ω)=h₀⁽¹⁾(kr)Y₀⁰(θ,φ)C₀(ω), (7)

where p_{dir}(x;ω) represents the direct sound emitted by the target source.

5. The accuracy of the extracted direct sound depends on the relative positions of the target noise source 22, probe microphones 24, and major background noise sources 38. As mentioned above, in this case it is necessary to know the locations of major background noise sources 38 and the direction in which background sound is traveling. The operator should place probe microphones 24 in between the target noise source 22 and major background noise sources 38 and point the probe at the target noise source 22 so as to produce best results possible.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers in method steps are for ease of reference in dependent claims and unless otherwise specified do not indicate a required sequence.

What is claimed is:

1. A method for extracting target sound radiation from a target noise source in the presence of background noise including the steps of:
a) measuring the acoustic pressures caused by the target noise source and by at least one background noise source at a plurality of locations in a sound field between the target noise source and the at least one background noise source;
b) describing the sound field using a first set of expansion functions for target sound radiation from the target noise source and a second set of expansion functions for background sound radiation from the at least one background noise source that travels in a direction opposite to that of the target sound radiation;
c) determining coefficients associated with first and second sets of expansion functions; and
d) extracting acoustic characteristics of the target sound radiation from background sound radiation based upon said steps a-c).

2. The method of claim 1 wherein said plurality of locations are around the target noise source.

3. The method of claim 1 wherein said plurality of locations are generally on one side of the target noise source.

4. The method of claim 1 wherein said step c) further includes the step of determining the coefficients using the Helmholtz Equation Least Squares (HELS) method.

5. The method of claim 1 wherein said step b) further includes the step of describing the sound field as:
$$p ( x ; ω ) = {\sum }_{j = 1}^{J} {Ψ}_{j}^{( 1 )} ( x ; ω ) {C}_{j} ( ω ) + {\sum }_{j = 1}^{J} {Ψ}_{j}^{( 2 )} ( x ; ω ) {D}_{j} ( ω ) , \qquad ( 1 )$$
where Ψⱼ⁽¹⁾ is given by
Ψⱼ⁽¹⁾≡Ψₙₗ⁽¹⁾(r,θ,φ;ω)=hₙ⁽¹⁾(kr)Yₙ^{l}θ,φ), (2)
where hₙ⁽¹⁾(kr) implies the spherical Hankel functions of order n of the first kind, k is the acoustic wavenumber, Yₙ^{l}(θ,φ) are the spherical harmonics, the indices j, n, and l in (2) are related via j=n²+n+l+1 with n starting from 0 to N and l varying from −n to n, and Ψⱼ⁽²⁾ in Eq. (1) symbolizes Ψⱼ⁽²⁾≡Ψₙₗ⁽²⁾(r,θ,φ)=hₙ⁽²⁾(kr)Yₙ^{l}(θ,φ), where hₙ⁽²⁾(kr) is the spherical Hankel functions of order n of the second kind.

6. A system for diagnosing noise comprising:
a plurality of transducers for measuring acoustic pressure in a sound field: and a computer for controlling the data acquisition process through the plurality of transducers, the computer modeling the sound field as target sound radiation from a target noise source and background sound radiation from at least one background noise source, the background sound radiation in a direction opposite to that of the target sound radiation, the compute extracting the target sound radiation from the background sound radiation to diagnose the target noise source.

7. The system of claim 6 wherein the computer describes the sound field using a first set of expansion functions for the target sound radiation and a second set of expansion functions for the background sound radiation.

8. The system of claim 7 wherein the computer determines coefficients associated with the first and second sets of expansion functions.

9. The system of claim 8 wherein the computer extracts the target sound radiation based upon the coefficients of the first set of expansion functions.

10. A method for extracting direct sound radiation from a target noise source in the presence of background noise including the steps of:
a) measuring acoustic pressures at a plurality of locations in a sound field between a target noise source and at least one background noise source;
b) describing the sound field as target sound radiation from the target noise source and background sound radiation from the at least one background noise source that travels in a direction opposite to that of the target sound radiation; and
d) extracting the target sound radiation from the background sound radiation.

11. The method of claim 10 further including the step describing the target sound radiation as a first set of expansion functions.

12. The method of claim 11 further including the step describing the background sound radiation as a second set of expansion functions.

13. The method of claim 12 further including the step of determining coefficients of the first and second sets of expansion functions.

14. The method of claim 13 wherein said step c) further includes the step of determining the coefficients using the Helmholtz Equation Least Squares (HELS) method.
